(19) United States
(12) Patent Application Publication
(10) Pub. No.: US 2014/0032230 A1
(43) Pub. Date: Jan. 30, 2014

(54) OPTION SERVICE UNIT (OSU) SYSTEM

(71) Applicant: Arthur Morris GELBER, Ridgefield, CT (US)

(72) Inventor: Arthur Morris GELBER, Ridgefield, CT (US)

(21) Appl. No.: 13/558,533

(22) Filed: Jul. 26, 2012

(51) Int. Cl. G06Q 50/22; G06Q 30/08

(52) U.S. Cl. 705/2

(57) ABSTRACT

The present method and system discloses an improvement to the existing relative value unit (RVU) service provided by Medicare and Medicaid which provides a set (arbitrary) value for a medical service and is not flexible and does not change to reflect the most current charges and payments for a specific medical procedure or service. The present system is an options service unit (OSU) system and is based on the principle that monetary value, i.e. compensation, should vary with the varying resource costs for providing those services.

### FIELD OF INVENTION

The present application is directed to a system for real time on line determination of unit value for medical procedures.

### BACKGROUND OF THE INVENTION

Presently there exists a relative value unit (RVU) service provided by Medicare and Medicaid. The RVU service provides a set (arbitrary) value for a medical service and is used by the insurance industry and providers (doctors, hospitals, etc.) to determine an accepted payment amount for a specific medical procedure or service. However, the RVU service is not flexible and does not change based on the most current charges and payments for a specific medical procedure or service.

The Medicare and Medicaid systems were developed to establish relative values of medical services using a numeric 5-digit coding system (referred to as common procedure terminology or CPT) to describe services and assign a unit value (UV) to each service. The term “relative value” was coined presumably because each service unit value could be measured in relationship to the values of other services. The Medicare and Medicaid systems approach to determining a reasonable charge or payment for a medical service(s) is to arbitrarily assign a charge or payment amount, which amount may change from one county to another. The present invention overcomes this arbitrary approach and adds other significant features to providing medical payments. As will be evident from the following description, the present invention is a transformation from the previous static system to a system that provides up to date charge and payment information while adding important quality measurement and pricing advantages for users that were not heretofore available.

The American Medical Association (AMA) publishes a listing of Common procedure terminology (CPT) for each medical procedure and service. HIPPA (Health Improvement Patient Protection Act) also publishes a listing of Data Set Standards, including Common procedure terminology (CPT) for each medical procedure and service. These Data Set Standards, such as CPT codes are used by the Medicare and Medicaid systems, doctors and others for identifying a particular procedure or service. Thus, the CPT codes are numbers assigned to every task and service a medical practitioner may provide to a patient including medical, surgical and diagnostic services. Because CPT's mean the same thing to those in the medical field, they ensure uniformity. That is, the CPT enables an understanding of what the service is, what clinical indications are implied (are proper reasons for that clinical procedure), etc.

### BRIEF SUMMARY OF THE INVENTION

In accordance with the present invention if a person needs or desires medical treatment he (referred to hereinafter as “user” and/or “bidder”) can request that service via the OSU System and may purchase option service units (OSU) from a provider to pay for any medical service or medical treatment provided via the OSU System. As used herein the terms “medical service,” “medical treatment,” “medical procedure,” “service,” “treatment” and “procedure” are used interchangeably since they each refer to what is being provided to a bidder and/or provided by a provider (e.g., a doctor, hospital, etc.). The OSU System maintains a computer with a listing of up to date real time listing of charges for each CPT service by zip code. Anyone accessing the OSU System (e.g., via the Internet) can determine the prevailing charges for each CPT service in each zip code. That is, the OSU System computer can be accessed to determine the prevailing payments for each CPT service in each zip code. The OSU System computer is constructed to maintain a listing by zip code of health care providers, medical services and treatments so that when a medical procedure is needed the patient and doctor using the OSU system will know the associated cost (which is subject to change as cost data is received and updated). Data in the OSU System is regularly updated so that the latest information about charges is available. The OSU System maintenance of a continuously updated system of payments for each CPT is a significant transformation from the previous static system where updated information was not available generally to the public and was not available in a format where a potential user could use the information to obtain quality care at a reasonable price.

The OSU System is built on a bid-ask model, which is not a managed care organization, but which pays claims for the delivery of health care services, accepts financial risk for the delivery of health care services and establishes, operates or maintains an arrangement or contract with providers relating to (A) the health care procedures and services rendered by the providers, and (B) the amounts to be paid to the providers for such procedures and services.

The OSU System also helps to ensure quality by maintaining a record of all CPT service and when approval for payment of a service is requested the OSU System can review the requested treatment with the latest standards of care guidelines relative to the treatment and the clinical indications for that ailment. If the review suggests the requested procedure is not among the latest accepted procedures for that ailment then the requested procedure is not accepted and a communication with the medical practitioner is implemented to determine the best way to proceed.

The OSU System determines the numeric (or dollar) value of an Option Service Unit (OSU). In one embodiment the numeric value of an OSU is determined by dividing the target price by a conversion factor (CF). In another embodiment the OSU System uses a conversion factor (CF) to assign a value based on the market driven monetary value of each unit. In yet another embodiment the OSU System determines a value for each unit based on actual market price paid and/or bid for a medical procedure or service. As will be evident from the following examples, the OSU numeric value can vary and it can be determined in a variety of ways depending, in part, on economic conditions.

Each care provider in the OSU System will agree to render a CPT service for a fixed number of OSU's. Such agreement can be for a fixed period of time or an indefinite period. Agreement may be based on occurrence of an event, e.g., the change in OSU amount for a CPT is an adjacent or corresponding zip code area. A person may purchase OSU's for indefinite future use or may purchase OSU's for more immediate use for a planned medical treatment.

### BRIEF DESCRIPTION OF THE DRAWINGS

The present invention will now be described in connection with one or more drawings, in which:

FIG. 1 is a flow chart of an example of a user obtaining and using OSUs.

FIG. 2 is a table demonstrating comparative values for medical services in different places (cities/counties).

FIG. 3 is another example of a listing of comparative values stored in the OSU System computer.

### DETAILED DESCRIPTION OF THE INVENTION

As will be outlined in detail below, the OSU service is flexible and changes with the most current medical charges and payments. The OSU system sells option service units (OSUs) at a predetermined price for each unit. Any person or organization can purchase OSUs at any time and use them for future or past service or they may keep them for future use. When a user needs or desires a medical service the user can purchase OSUs from the OSU system provider (or may already have previously obtained an amount of OSUs) and, using the OSU system, the user submits a bid for the desired medical service to be provided to the user, the bid listing the number of OSUs the user is willing to pay for the medical service.

A bid for a desired medical service or procedure may, or may not, include more than just the amount the bidder is willing to pay. For example, a bid may ask (or require) that the medical procedure or service be performed (or provided) in a particular location or locations. A specific or group of providers (e.g., physicians) may be specified. A date or date range for the medical procedure or service to be performed (or provided) may be indicated. Other similar factors may be included in a bid. As will be evident from the following discussion, bids are to be listed in the OSU System and the OSU System will solicit and accept offers from an asker (medical service provider). Any conflicts (e.g., difference in the amount bid versus the amount asked, the choice of physician who will provide the service, etc.) will be the subject of counter offers and bids until an agreement is reached.

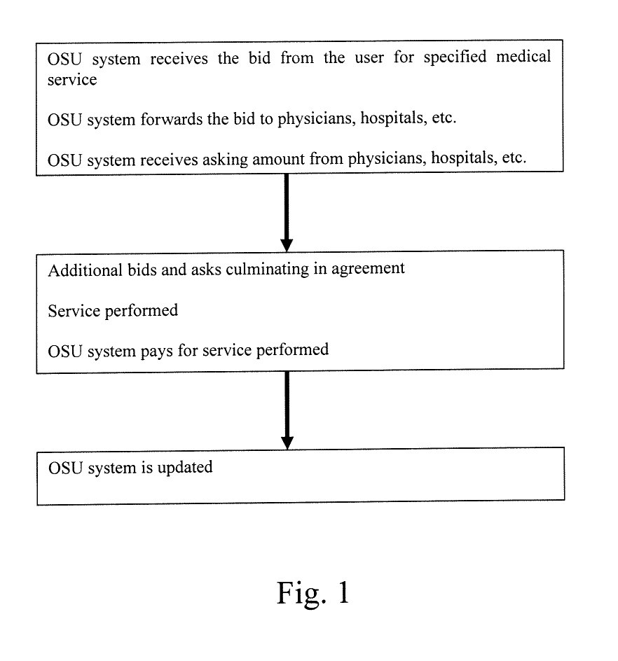

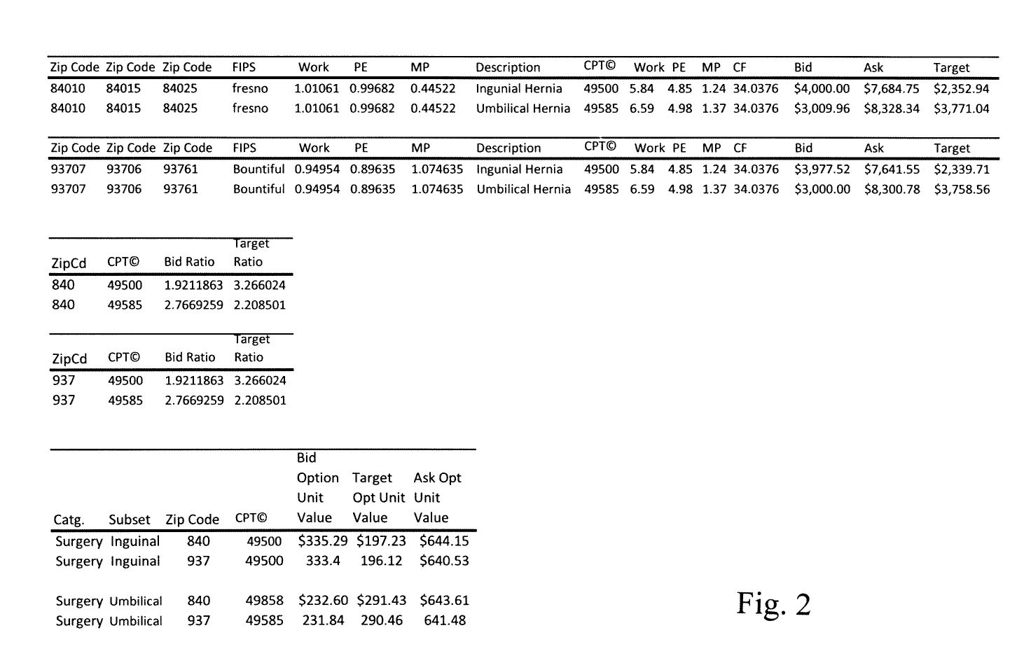

FIG. 1 is a flow chart showing one example of using the OSU system. As seen in FIG. 1, the OSU system receives the bid from the user for the specified medical service to be provided to the user, the bid listing the number of OSUs the user is willing to pay for the medical service. The bid will commonly also include other information about the user, e.g., name, age, medical history, and preferred location(s) where the medical service is to be provided. It is to be understood that the OSU System will be available to assist the bidder with his bid by providing a listing of medical services (e.g., listed as CPT's), the zip code (or other location) where the service is provided, a target price (in OSU's) for the service and other information such as previous bid and ask amounts for such service. FIG. 2 is a sample OSU System listing that is useful to a user to enable the user to determine the amount of his/her bid and such other factors as, for example, the location where the service is provided for the least (or most—if it is assumed that higher cost means better quality) amount. The OSU System listing (FIG. 2) may also facilitate informing the user as to where the desired service is available and is not available.

The OSU system will forward the request for the medical service to be provided to likely medical service providers (physicians, hospitals, etc.) and request each medical service provider to bid on providing the medical service. The providers may then submit an asking amount to the OSU system for the medical service to be provided to the user, the asking amount listing the number of OSUs the medical service provider is willing to accept for providing the medical service.

The bid/ask procedure may be repeated until there is agreement on the amount (and any other conditions) for performing the medical service. After agreement and after the medical service has been provided, the OSU system will pay the agreed amount of OSU's to the medical service provider.

The OSU system maintains target prices for medical services and strives to encourage that provided medical services stay within those target prices. Obviously, it is not always possible to do so. For example, if no OSU value is available for a specific procedure in a specific zip code (county, etc.) then when a request is received for the specific procedure physicians (or other provider(s)) in the zip code or other area are requested to bid on the procedure and the average bid is used to determine an initial OSU amount for that procedure in that zip code area. Alternatively, an OSU value may be assigned based on an existing OSU value for the specific procedure in another zip code area. Once an initial OSU value exists for a specific procedure in a specific zip code then it may be changed based on future bids and/or contracts for the procedure in the specific zip code area. This is an important difference between the Medicare/Medicade System wherein there is no computer tracking of bid and asked amounts as well as of the agreed on amount for a medical service with the target amount for such medical service being based on past transactions in that zip code. The OSU System unlike the Medicare/Medicade System updates the data in the system as agreements are reached and/or as services are provided. The updates are useful to determine a target amount for the service based on previous agreed amounts and services provided. For example, in a specific location (e.g., a specific zip code) if for a particular CPT there is a series of agreed amounts for which service is provided then the OSU System looks at the trend (e.g., increase or decrease in amount) of the agreed amount and provides a target amount in the OSU System listing for that CPT in that location (zip code). The target amount may simply be an average of the total agreed amounts in the system for that CPT in that zip code, it may be an average only for agreed amounts for that CPT in the last few (e.g., 5) years, it may be an average for agreed amounts for that CPT in several zip codes judged to be similar (e.g., similar cost of living, etc.) and/or it may be an estimated amount for that CPT based on the increasing (or decreasing) rate of inflation or of other factors such as the change in malpractice insurance.

As is evident, an existing OSU value may be changed based on existing OSU values in one or more other zip code areas. For example, in some zip code areas there may be few occurrences of a particular medical service such that it is difficult to estimate a target amount for that CPT service in that zip code. In that case it may be possible to obtain a target amount from a comparable zip code. That is, the computer searches its data base for a comparable zip code (e.g., comparable economic conditions, comparable population, urban/rural factors, availability of physicians/providers with the appropriate capability, etc.) and determines a target amount using the target amount from one or more comparable zip codes.

At this point it should be clear that the OSU system is market driven in that it constantly is updating the bid, asked and agreed on amount for medical services. The OSU system promotes competition (e.g., providers may bid on a procedure, which bidding tends to reduce the bid amounts for that procedure and future procedures) and is able to provide a more realistic pricing for medical services. If market conditions change, e.g., new medical implements and/or machines become available then asking prices may rise due to the costs associated with such new devices. In this regard it is clear that the computer based OSU system is transforming providing medical services by, for example, providing a bid/ask system and providing a computer based system that maintains a listing of current procedures and costs for those procedures by zip code. Using the OSU System one can compare the various provider factors for a specific procedure so as to enable a more informed bid. For example, a computer search of the OSU System for a given CPT will provide the searcher (e.g., potential bidder) with a listing of the range of costs for that procedure and showing the zip code for each cost listing as well as possible providers (e.g., specific physicians, specific medical facilities, etc.). This permits the user to make a bid with not only the cost in mind, but also the provider possibilities (e.g., where the provider is available to provide the service, a listing of the providers and their qualifications, etc.). Of course, a bid may be tailored to include a specific provider of the bidders choice.

The OSU system even enables checks on quality of the medical services being provided. For example, the OSU System can review whether a requested procedure is the latest accepted procedure (or one of the latest accepted procedures) for the ailment sought to be corrected. If the review finds that the requested procedure is not the most (or among the most) accepted then the OSU system will implement communication with the medical practitioner and/or the user seeking the medical service to determine the best way to proceed. The OSU System will maintain a listing of qualified (and unqualified) providers so as to help ensure that quality medical service is provided. For example, an unqualified provider may be listed as such and no asking amounts may be accepted from such providers.

The OSU System quality assessment includes the possibility for a real time utilization review. The OSU System will maintain a list of clinically accepted reasons for each CPT and when a bid is accepted the provider will be asked to indicate a reason for the medical service (if provider has not already done so). If the reason indicated is not one of the clinically accepted reasons for that CPT then the OSU System will initiate a review process to ensure that the medical service is appropriate. The OSU System may block payment where one of the clinically accepted reasons for the CPT is not indicated. Where a clinically accepted reason for a CPT is indicated the OSU System will automatically forward payment upon performance of the medical service. The review process may, for example, involve review of medical literature listings for a clinically accepted reason for the CPT, review by one or more providers selected by the OSU System to determine if a clinically accepted reason is present for the CPT and/or may include query to the bidder for more information with indication to the bidder that a clinically accepted reason is not present for the CPT.

The options service unit (OSU) system is configured to accept a user desiring a medical service and to permit the user to access the OSU system's most current payment and service provider information. In this manner the user has the option to accept the OSU's target amount for the desired medical service in a specific zip code area rather than to try come up with an amount without some guidance as to what is customary in the area where the service is to be provided. This permits a user to shop for service in a variety of zip code areas and to base their bid on best price, best physician, etc. The user can use the OSU target amount as a starting point for the user's bid amount for the medical service the user is requesting. Similarly, medical service providers (physicians, hospitals, etc.) may likewise prefer to agree to accept the OSU's target amount for the desired medical service and such acceptance can be for a specific request by a user or acceptance can be ongoing until the service provider desires a change.

Regardless of how the price for a medical service is decided, after providing the medical service to the user, the OSU system will pay the medical service provider by transferring to the medical service provider the option service unit (OSU) amount agreed on and then the OSU system will update the system's common procedure listing to reflect the amount paid whereby the system will have an up-to-date CPT listing by zip code. That the OSU System ensures payment helps to reduce providers costs which inevitably reduces costs to users.

The options service unit (OSU) system is based on the principle that monetary value, i.e. compensation, should vary with the resource costs for providing those services. The OSU System provides an Exchange that will rank services according to the relative cost required to provide a service. The Exchange compares a service in relation to other services. Some procedures are more complex and time consuming than others and some require more resources than others. In determining a value, each procedure has been given a relative value. An OSU has three components and those components may vary based on the nature of the procedure or service as mentioned above.

The OSU for each procedure is primarily based on the components below:
Physician Work reflects the physician's time, skill and intensity required for the services.
Practice Expense reflects the physician's direct expense which include: office rent, staff, supplies, equipment and other overhead that may be required to provide the service. The practice expense can vary based on the site of service, i.e., whether the procedure was performed in the physician's office or in a hospital setting.
Practice Liability Expense reflects the professional liability or malpractice expense to the physician to provide a service.

An important advantage to a provider (physician) is that the payment (in OSUs) is guaranteed by the OSU System. An important advantage to the user is that competition among providers enables providing the lowest cost to the user. That is, the user has the advantage of being able to access the OSU System and determine previous agreed on amounts for the medical service the user is seeking. As more and more users and providers use the OSU System a competitive market driven price for each CPT will be achieved. An advantage to a user is that the user may travel to a zip code having the lowest (or one of the lowest) costs for the desired medical service. And users will be able to select (via the user's bid) a physician based on a variety of factors, e.g., price that a specific physician has agreed on for previously delivering the same medical service, location of a desired medical service provider, quality of medical service provider, etc. It should be evident that as the OSU System gains popularity in the US, medical costs in the US will be reduced to a fairer level and the US will no longer be among those countries having the world's highest average costs for good medical service.

The present invention is directed to a methodology for issuing OSUs and involves establishing relative values of medical services. As discussed above, the term “relative value” was coined because each service unit value could be measured in relationship to the values of other services. At this point it should be clear that RVUs (e.g., those used by the Medicare/Medicade System) are an assigned value whereas OSUs vary as conditions (bid/ask amounts, provider costs, economic conditions, etc.) change. An example of economic condition change is inflation. The US Government publishes statistics on inflation (changes to costs of goods and/or services) and it is contemplated that in another embodiment the value of an OSU can be changed based on inflation. Thus, if, for example, there is 5% inflation then the OSU value may be changed by 5% (or a reasonably similar amount) to reflect the inflationary change in the affected zip codes. This demonstrates that the OSU System is a “real time” system that is “interactive” whereas the RVU system suffers from remaining stagnant in spite of real time changes in the market place. The RVU system assigns acceptable amounts which amounts remain fixed in spite of actual changes in the market place, e.g., actual procedures performed for prices different from the RVU assigned amount. The RVU system is not subject to input from users and providers whereas the OSU System uses information to constantly update actual bid, asked and accepted amounts.

FIG. 2 is an example of a listing of some of the data stored in the OSU System computer. Zip Code means the U.S. Postal Service zip code and FIPS (Federal Identification Postal Service) reflects the city, county, etc. For example, as seen in FIG. 2, zip codes 84010, 84015 and 84025 are shown as the zip codes for Fresno (Calif.). In the first line of the chart in FIG. 2 headings are provided for the information listed below each heading. In the second line “Inguinal Hernia” is listed as a medical procedure and “49500” is the CPT code for that procedure. The second line lists a bid of $4,000 and ask of $7,684.75 for the Inguinal Hernia procedure. The target amount of $2,352.94 may result from an average of previous amounts paid for the Inguinal Hernia in zip codes 84010, 84015 and 84025. Or the target amount may result from an estimated amount (e.g., based on amounts from another or other zip codes) if there have been no Inguinal Hernia procedures in zip codes 84010, 84015 and 84025. Other possible target amount determinations are contemplated and are evident from the present disclosure. As is evident, the FIG. 2 layout may be on an Excel spreadsheet and the listed amounts may result from formulas as used in an Excel spreadsheet.

The Bid Ratio shown in FIG. 2 results from dividing the asking price by the bid amount. FIG. 2 shows a bid ratio of 1.9211863 for CPT 49500 in zip code 840. That is, 7,684.75÷4,000=1.9211863. The Target Ratio results from dividing the asking price by the target amount. That is, 7,684.75÷$2,352.94=3.266024. As will become evident from subsequent discussion, the bid ratio and target ratio provide guidance in estimating bid, ask and target amounts. MP reflects the malpractice costs. PE reflects the practice expense costs.

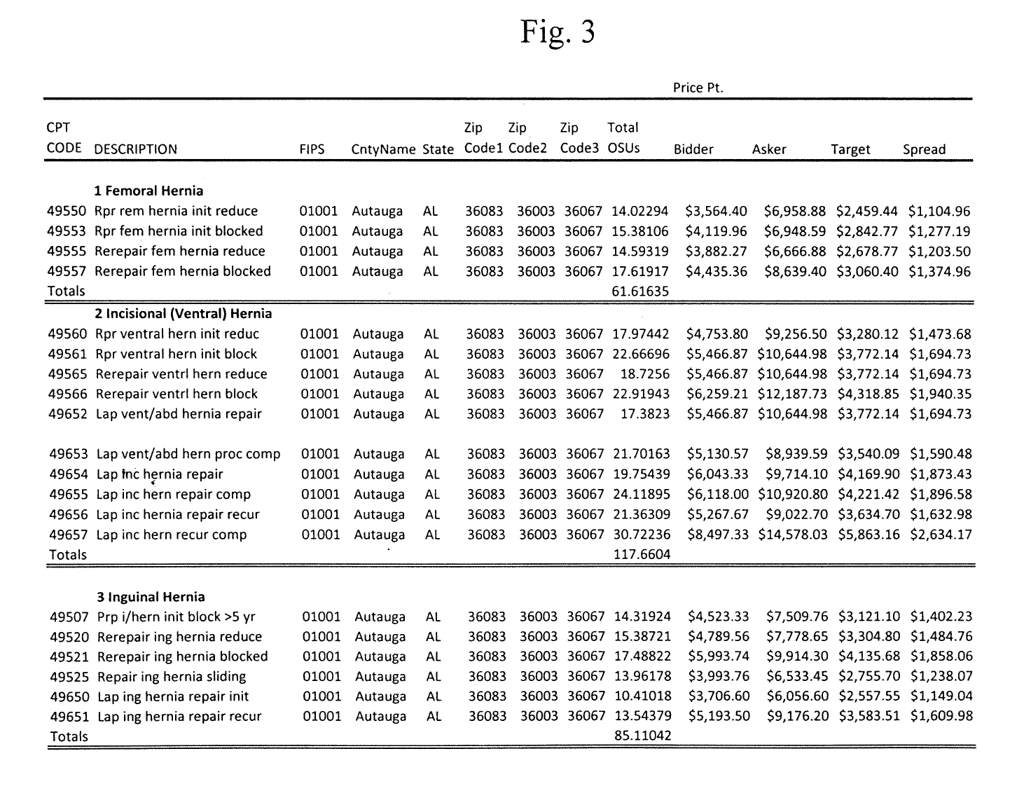

FIG. 3 is another example of a listing of some of the data stored in the OSU System computer. In FIG. 3 each line begins with a specific CPT listing and also includes a county name. It should be evident that the FIG. 2 and FIG. 3 listings enable a computer (e.g., Excel type) search for information in a variety of ways. For example, one could list all available information (previous bid, ask and target amounts) for a specific CPT in a particular location (city, county and/or zip code). Such information being an advantage to a user wishing to make a bid.

### Calculating Resource Costs

With OSUs, the target value of a procedure or medical care service relative to another procedure or medical care service may be set based on a conversion factor. That is, a conversion factor may be used for a particular procedure or service (a particular CPT) to adjust for differences in costs to providers. For example, a provider may pay more (or less) than another provider for use of an operating room to provide a CPT. Due to varying costs, contractual advantage, etc., a provider may pay more (or less) than another provider for use of equipment, assistants (e.g., nurses), transportation, education re latest procedures, etc. Some providers have the latest equipment not available to others providing the same CPT service. To account for this variation in costs to the provider, a “conversion factor” is used to convert a target amount for a CPT into a more accurate target amount for the desired medical service. The OSU System uses a conversion factor where it is necessary, desirable and/or appropriate as deduced from actual or apparent differences in costs to providers. The use of a conversion factor is mentioned here because such conversion factors are useful to compensate for differences in practice yet to enable a comparison of a CPT service performed under different conditions (e.g., using different equipment, at different locations, etc.). A conversion factor is helpful to level the playing field where appropriate; it is not used in most cases.

### Facility and Non-Facility Fees

Many of the physician services can be performed in either an office setting or a facility setting, which may include hospital inpatient, outpatient, ASC, etc. As mentioned above, one of the components of the OSU calculation is that of Practice Expense. When physician services can be performed in either a facility or a non-facility setting, the following values account for the practice expense:

Non-Facility Practice Expenses represent the physician's direct and indirect cost related to providing that service in the physician's office, patient home or other non-hospital setting. Those expenses could include rent for office space, employees, supplies, equipment, etc.

Facility Practice Expenses represent the physician's direct and indirect cost of providing a service in a facility setting. The expenses of rent, supplies, labor and equipment are part of the cost of the facility where the service is being rendered.

### Site-of-Service

The OSU specific to the site-of-service provides the ability to establish a physician fee that is appropriate to compensate for the physician's costs associated with performing a given procedure in a particular setting. In most cases, the physician practice expense in the office setting is higher than it would be in a hospital. The result of the difference is a higher OSU in the office resulting in a higher fee.

### How the Health Care Services Exchange (HCSE) and Others Will Use its Options Service Unit Methodology

If the consumer or provider of care wants to have the prevailing resource costs for an office visit for a new patient the Exchange's (e.g., HCSE) system will look at a range of services (for example, the new patient office visits) have a unit value (measured in relative value unit or OSUs) assigned to each CPT code. In this example the proprietary conversion factor used is $50.00 and the RVU is 0.91 to demonstrate how to arrive at a set of fees.

### 1. Algorithm

Example 1 (10 Min.). No fees established choose a Conversion Factor (CF) and calculate a fee (UV×CF=Fee).

### Or, 0.91×$50=$45.50

Since the resource costs or monetary value has yet to be determined the Exchange will provide the prevailing CF for a specific zip code. The prevailing CF is based on calculating the weighted average CF (CF=Mean of [calculated CFs×Frequency]). This calculation is done when either the buyer or seller of the option hasn't determined a target price, they are without a OSU scale, and they want to evaluate their target price before entering into the system a call or put option.

The weighted conversion factor is the figure that represents the value of the medical service in the marketplace and is the place from which all opportunities are evaluated and performance is measured.

There are two benefits from this calculation:

First it shows the wide variation in the individual calculated conversation factors.

Second, it shows the overall weighted average conversion factor, which allows the buyer and the seller to calculate several things, including usual and customary charges and net savings or gains.

In the case of the practice/facility the weighted average conversion factor allows the practice to calculate discounts to fee-for-service contracts, revenue performance from the practice's billing operations, and performance of capitated contracts. The conversion factor could be compared to the expected payments (expressed as a conversion factor) from each payor class. These expected payments would be used, along with their payor mix, to calculate an overall collection target price.

### 2. Algorithm

Example 2. BASIC OPTION: Target Price[TP] established Calculate CF (TP÷UV=CF).

In example 2 the Exchange will calculate the Weighted Average CF (CF=Mean of [calculated CFs×frequency]). The benefit of this calculation is in comparing those conversion factors. The exchange will assign a proprietary numerical values to the work, practice expense and insurance liability, and the values will differentiate a medical office from an ambulatory surgery center or an ambulatory center from a hospital's outpatient and inpatient care. Programmatically, “real-time” service and place of service data will process through a series of algorithms to derive the specific services relative value. Calculating a particular service's relative value is only a partial component to determining the pay for the service.

The exchange has developed a proprietary Geographical Health Care Service Index (GHCSI). After the Exchange determines the numerical value of a service's work, practice expense and professional liability insurance OSUs, the algorithms will adjusts each of those OSUs using the GHCSI in a effort to reflect broad differences in the costs of operating health care services in approximately 43000 ZIP Codes in the United States. The Exchange will continue to improve the accuracy of the Geographical Health care Service Indices (GHCSIs) through the use of accurate costs and timely data.

The work GHCSI will reflect the physician's earning. The expense GHCSI adjusts the expense OSU to reflect geographic differences in the prices of medical practice inputs (e.g., office rent per square foot and staff hourly wages) in the Zip Code.

Once the system determines a service's relative value, the Exchange will apply a proprietary conversion factor. To determine the payment for a medical service the system will multiply the relative value of that service by the Exchange's conversion factor. The option data will determine the scope of the conversions factors used by the Exchange, for instance conversion factors can be used to calculate payment for surgical, specialty and primary care services. OSUs are divided into five sections: Medicine, Surgery, Anesthesia, Radiology, and Pathology. Each section has its own set of unit values that did not relate to the values in the other sections: consequently, each section has its own conversion factor. The Exchange will be using a system of unit values that allows the relationship between sections and the ability to use one conversion factor for the entire scale.

### The Formula for Calculating the Option's Relative Value

Non-Facility Option Target Price=Work OSU*Work GHCSI+Non-Facility PE OSU*PE GHCSI+MP OSU*MP GHCSI+Conversion Factor (CF) 1.

Facility Option Target Price=Work OSU*Work GHCSI+PE OSU*Facility PE GHCSI+MP OSU*MP GHCSI+Conversion Factor (CF) 2.

As noted above, there are numerous variations and equivalents of the present invention that should be appreciated by those skilled in the art. The present invention is intended to encompass those equivalents and variations. The US and indeed the world has numerous zip codes or location codes. The present invention is demonstrated by examples with each example including at least one location code and a CPT's. The number of location codes is very large as is the number of CPT's. A complete listing of all location codes and all CPT's would obviously be quite voluminous and somewhat repetitive. The present disclosure demonstrates all of the features of the invention with examples and discussion, but without being unduly verbose and repetitive. One of ordinary skill in the art will appreciate the details, scope and breadth of the present invention notwithstanding that all possible locations and HIPPA'S Data Set Standards, such as CPT's are not listed in the present specification.

What is claimed is:

1. A computer implemented method of providing a health care service comprising
maintaining HIPPA's Data Set Standards, including a common procedure terminology (CPT) listing of health care services on a computer,
maintaining on the computer a listing of location codes for a variety of geographical areas,
maintaining a listing of the most recent amounts paid for each CPT in each of the listed geographical areas,
permitting a user access to the CPT listing, the location codes and the most recent amounts paid,
receiving a bid from a user for a CPT procedure for a medical service,
forwarding the bid to a medical service provider,
reaching an agreement between the user and provider on the amount for the CPT procedure and entering the agreed on amount into the computer and making the updated amount available to potential users.

2. The computer implemented method of claim 1, further comprising
selling option service units (OSUs) at a predetermined price for each unit,
receiving a bid from a user comprises listing the number of OSUs the user is willing to pay for the medical service,
receiving an asking amount from a medical service provider for the medical service to be provided to the user, the asking amount listing the number of OSUs the medical service provider is willing to accept for providing the medical service.

3. The method of claim 1 further comprising wherein
the bid from the user includes an ailment sought to be corrected and after receipt of the bid and of an asked amount by a medical service provider and wherein the asked amount includes a proposed CPT procedure for correction of the ailment,
comparing the CPT medical service submitted by provider with accepted medical procedure for the ailment sought to be corrected,
if the medical service submitted by provider is the same as the accepted medical procedure authorizing payment for the medical service, and
if the requested procedure is not the same as the accepted medical procedure sending a communication to the provider requesting reasons for proceeding with the requested procedure.

4. The method of claim 1 further comprising
establishing an option service unit (OSU) account for the user whereby the user purchases option service units (OSUs) from an account provider, and
establishing an option service unit (OSU) account for the medical service provider whereby the medical service provider can purchase and redeem option service units (OSUs) from the account provider.

5. The method of claim 1, wherein each location code comprises a zip code.

6. The method of claim 5 further comprising
determining the prevailing payments for a provided common procedure in different zip code areas, and
updating the listing of the most recent amounts paid for each CPT in a specific zip code area to reflect received bid, asked and agreed on amounts.

7. The method of claim 2 further comprising changing the computer value of an OSU based on inflation.

8. The method of claim 1 wherein the agreed on amount is entered into the computer after performance of the CPT procedure.

9. A method of enhancing the quality of medical service comprising,
providing a common procedure terminology (CPT) listing of health care services to potential users, wherein the CPT listing is on a computer having a listing searchable for a variety of geographical areas and wherein each geographical area has a listing of the most recent amounts paid for each CPT listing in that geographical area or has a listing of an estimated amount to be paid for each CPT listing in that geographical area,
receiving a bid from a user for correction of an ailment,
receiving an ask amount from a medical service provider for a CPT to be provided to the user for correction of the ailment,
determining if the CPT is listed among a listing of accepted medical service providers for the ailment.

10. The method of claim 9 comprising determining if the medical service provider is listed among a listing on the computer of accepted medical service providers.

11. The method of claim 9 wherein the step of receiving an ask amount from a medical service provider for a CPT to be provided to the user for correction of the ailment includes reasons given by the provider, and
determining if the reasons given for the CPT are listed among a listing on the computer of accepted reasons for the CPT.

12. A method of providing and paying for a medical service comprising
maintaining a common procedure terminology (CPT) listing on a computer,
maintaining a listing of the most recent amounts paid for each CPT in a specific zip code area,
making the CPT listing and most recent amounts paid available to users and providers,
receiving a request from a user for a medical service to be provided to the user,
providing the user with search results of the computer data revealing the lowest target amount for a CPT for the requested medical service in a zip code convenient to the user,
obtaining agreement by the user and a medical service provider on an amount for the medical service to be provided to the user and
updating the computer to indicate the agreed on amount for the CPT.

13. A computer implemented method of providing and paying for a medical service comprising:
establishing an option service unit (OSU) account for a patient whereby the patient purchases option service units (OSUs) from an account provider;
providing a medical service to the patient;
determining the common procedure terminology (CPT) for the medical service provided to the patient;
determining the zip code location where the common procedure terminology (CPT) was provided to the patient;
determining the option service unit (OSU) amount assigned to that common procedure in the zip code location where the common procedure terminology (CPT) was provided to the patient; and
paying the medical service provider by transferring to the medical service provider the option service unit (OSU) determined amount.

14. The method of claim 13 wherein determining the option service unit (OSU) amount comprises
determining an average of physician work and time for performing the specific medical service; and
determining an average of office space, staff and supplies for performing the specific medical service.

15. The method of claim 13 wherein determining the option service unit (OSU) amount comprises determining practice liability expense for performing the specific medical service in the relevant zip code.

16. A method of providing and paying for a medical service comprising
maintaining a common procedure terminology (CPT) listing on a computer,
maintaining a listing of the most recent amounts paid in option service units (OSUs) for each CPT by specific zip code area,
making the CPT listing and most recent amounts paid available to users and providers,
receiving a bid in OSUs from a user for a medical service to be provided to the user,
receiving an asking amount from a medical service provider for the medical service to be provided to the user, the asking amount listing the number of OSUs the medical service provider is willing to accept for providing the medical service,
after agreement by the user and medical service provider on the amount of OSUs for the medical service to be provided to the user updating the computer to indicate the agreed on amount and the CPT for the medical service to be provided.

17. The method of claim 16 wherein maintaining a listing of the most recent amounts paid in OSUs for each CPT by specific zip code area includes establishing the computer value of an OSU in a specific zip code area having no actual agreed on listings in the most recent twelve months based on prevailing payments for a CPT in at least one other different zip code area having an actual agreed on listing for the CPT in the most recent twelve months and wherein the other different zip code area has a cost of living similar to the cost of living of the specific zip code area.
